(19) United States
(12) Patent Application Publication
(10) Pub. No.: US 2009/0239132 A1
(43) Pub. Date: Sep. 24, 2009

(54) OXYGEN BATTERY SYSTEM

(75) Inventor: Lonnie G. Johnson, Atlanta, GA (US)

Correspondence Address: BAKER, DONELSON, BEARMAN, CALDWELL & BERKOWITZ;Intellectual Property Department, Monarch Plaza, Suite 1600, 3414 Peachtree Rd., ATLANTA, GA, 30326, US

(73) Assignee: EXCELLATRON SOLID STATE, LLC, Atlanta, GA (US)

(21) Appl. No.: 12/406,370

(22) Filed: Mar. 18, 2009

Related U.S. Application Data
(60) Provisional application No. 61/038,173, filed on Mar. 20, 2008.

(51) Int. Cl. H01M 2/00

(52) U.S. Cl. 429/61

(57) ABSTRACT

A lithium oxygen cell system (10) includes a battery cell (15), a containment vessel (106) having an air inlet conduit (114) and an air outlet conduit (112). An access control valve (101), a one way check valve (102), a H₂O scrubber (103) and a CO₂ scrubber (104) are mounted within inlet conduit. A one way check valve (107) and a forced air device (108) are mounted within outlet conduit. A charge controller (109) is coupled to battery and to the air device. The pair of one way check valves insure that the inside of the containment vessel (106) may be sealed. The system further includes a safety controller (111) coupled to an environmental sensor (110), and to control valve (101). When an unsafe temperature or pressure condition is detected, it closes control valve to shut down operation of the battery and thereby prevent a catastrophic event.

### REFERENCE TO RELATED APPLICATION

Applicant claims the benefit of U.S. Provisional Patent Application Ser. No. 61/038,173 filed Mar. 20, 2008.

### TECHNICAL FIELD

This invention relates to oxygen batteries, and specifically to oxygen battery systems having safety features.

### BACKGROUND OF THE INVENTION

Batteries using metallic lithium anodes have posed severe safety issues due to the combination of a highly volatile, combustible electrolyte and the active nature of the lithium metal. These batteries store energy as a chemical reaction potential between internally contained materials. Internal failures resulting in self discharge can produce a high current generation, overheating and ultimately, a possible fire.

The main problem associated with metallic lithium anodes has been mossy lithium growth during recharge. Low density lithium plating during the recharging process can grow through the separator/electrolyte resulting in an internal short circuit. The heat generated by the short circuit vaporizes the volatile electrolyte which can cause decomposition of active cathode materials with an associated release of oxygen. These cells can degenerate to the point where high temperature levels in combination with volatile electrolyte and mossy lithium participates in a burning reaction releasing high levels of energy and a violent rupture of the battery casing or containment vessel.

Lithium-ion batteries were developed to eliminate mossy lithium growth by using graphite based anodes to intercalate the lithium. Although these batteries are much safer than earlier designs, violent failures may still occur. The problem is that conventional lithium ion batteries contain all of the chemical reactants necessary to produce the reaction energy potential of the cell. An internal failure can cause these materials to react with each other and violently release their stored energy as heat. Access of internal reactants to each other in the event of an internal failure cannot be controlled in lithium ion (Li-Ion) cells.

Lithium-air batteries produce electricity by the electrochemical coupling of a reactive lithium anode to an air (oxygen) cathode through a suitable electrolyte within a cell. During cell operation metal ions are conducted into the cathode where they react with oxygen thereby providing a usable electric current flow through an external circuit connected between the anode and the cathode.

Lithium oxygen cells using non-aqueous electrolyte lithium air cells contain only the anode reactant. Should an internal failure occur, only a measured amount of energy is released based upon the available oxygen within the cell.

Hence, there remains a need for an air battery system which may be operated safely in the event of a failure. It is to the provision of such therefore that the present invention is primarily directed.

### BRIEF DESCRIPTION OF THE DRAWINGS

FIG. 1 is a schematic view of a lithium air cell.

FIG. 2 is a schematic view of a lithium air cell mounted within an enclosure.

FIG. 3 is a schematic view of a lithium air cell system in a preferred form of the invention.

FIG. 4 is a schematic view of a lithium air cell system in another preferred form of the invention.

### DETAILED DESCRIPTION

With reference next to the drawings, there is shown a lithium oxygen cell system 10 in a preferred form of the invention. The lithium oxygen cell system 10 includes a lithium oxygen electrochemical cell, lithium oxygen battery cell or lithium air cell 15 (these terms used interchangeably herein) constructed using carbon (carbon black based cathodes (with or without an added oxygen dissociation-promoting catalyst such as manganese dioxide) dispersed within a polymeric binder material and incorporating a metal screen as the conductive element. Maximum specific energy storage capacity is achieved with the use of lithium metal as an anode; however, graphite lithium intercalation anodes can be used to form lithium ion air cells using an appropriate separator design.

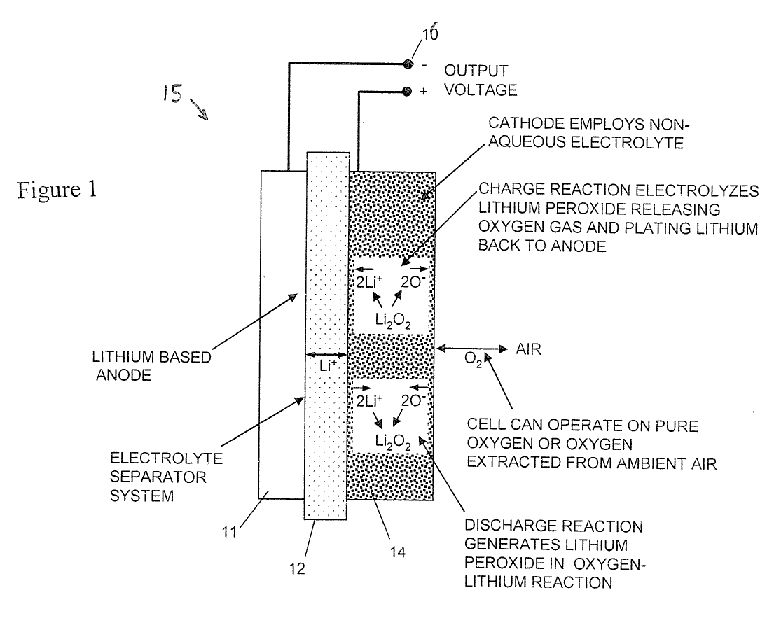

As best shown in FIG. 1, the lithium air cell 15 includes a lithium anode 11, an electrolyte separator 12, an air cathode 14 and battery terminals 16. Lithium-air cells or batteries produce electricity by electrochemically coupling a reactive lithium based anode to an air (oxygen) cathode through a suitable electrolyte in a cell. During discharge, the cell consumes oxygen from its environment. Metal ions are conducted by the electrolyte through separator 12 into cathode 14 where they react with oxygen providing a usable electric current flow through an external circuit connected to terminals 16. The reaction products are generally lithium oxide (Li2O) and/or lithium peroxide (Li2O2), preferably lithium peroxide for electrochemically reversible cells. The cell is recharged by applying power to terminals 16 to electrolyze the lithium peroxide reaction product. Lithium ions are conducted back to the anode to reconstitute the anode and oxygen is released from the cathode back to the environment during the process.

The cell 15 in FIG. 1 incorporates Teflon bonding and a Calgon carbon (activated carbon) based air cathode. It is prepared by first wetting 14.22 g of Calgon Carbon, 0.56 g of Acetylene black, and 0.38 g of electrolytic manganese dioxide by a 60 ml mixture of isopropanol and water (1:2 weight ratio). The electrolytic manganese dioxide is an oxygen reduction catalyst, preferably provided in a concentration of 1% to 30% by weight. Alternatives to the electrolytic manganese dioxide are ruthenium oxide, silver, platinum and iridium. Next, 2.92 g of Teflon 30 (60% Teflon emulsion in water) is added to the above mixture, mixed, and placed in a bottle with ceramic balls to mix overnight on a ball mill. After mixing, the slurry/paste is dried in an oven at 110 degrees Celsius for at least 6 hours to evaporate the water, and obtain a dry, fibrous mixture. The dry mixture is then once again wetted by a small quantity of water to form a thick paste, which is then spread over a clean glass plate. The mixture is kneaded to the desired thickness as it dries on the glass plate. After drying, it is cold pressed on an Adcote coated aluminum mesh at 4000 psi for 3 minutes. To remove any cracks in the paste, the cathode assembly is passed through stainless rollers. The cathode is then cut into smaller pieces such that the active area of the cathode is 2 inches by 2 inches. A small portion of the aluminum mesh is exposed so that it may be used as the current collector tab.

The cell 15 assembly is performed inside of an argon filled glove box. The cathode is wet by a non-aqueous organic solvent based electrolyte including a lithium salt and an alkylene carbonate additive. The electrolyte may be lithium hexaflouraphosphate (1MLiPF6 in Propylene Carbonate: DiMethel-Ethlylene (PC:DME)). A pressure sensitive porous polymeric separator membrane (Policell, type B38) is placed on the cathode. Next, a thin lithium foil is placed on the wet separator, and a 1.5 cm×4 cm strip of copper mesh is placed along one edge, away from the aluminum mesh tab. This assembly is laminated on a hot press at 100 degrees Celsius, and 500 lb of force for 30 to 40 seconds. After the sample is withdrawn from the press, the heat activated separator binds the sample together. It should be understood that the separator is loaded with an organic solvent based electrolyte including a lithium salt and an alkylene carbonate such as vinylene carbonate or butylene carbonate.

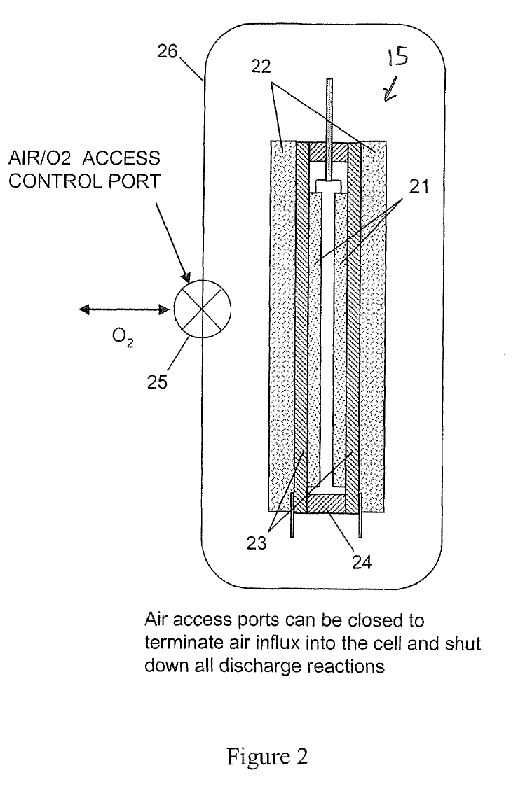

With reference next to FIG. 2, there is shown a pair of back to back lithium air cells 15 mounted in a protective enclosure 26 to form a battery. Oxygen is supplied to the cells through access control port 25 in the enclosure 26. The cells are configured having cathodes 22 exposed to oxygen contained in enclosure 26. Each cathode 22 has an electrolyte separator 23 attached thereto with anode 21 attached to the separator 23. Two distinct electrochemical cells are formed such that each anode 21 and cathode 22 pair is coupled together by a separator 23. The cells are configured back to back and bonded to each other by bonding material 24. This configuration limits exposure of the anode to the oxygen or air contained in the cell. During discharge, access port 25 is opened to allow oxygen to enter the cell as it is consumed. On the other hand, access port 25 is opened to allow oxygen to escape as it is generated when the cell is being charged.

The access port 25 can function as a safety feature to prevent catastrophic failures. When the cell is being charged, oxygen is continuously removed from the cell so as to limit the amount available in a catastrophic, runaway situation, i.e., a failure. With port 25 closed, a potentially fire is starved of oxygen before it can propagate.

The battery includes a safety system which monitors the internal pressure and temperature of the cell 15 in order to detect unsafe operations, such as an internal short circuit or excessive operational loading rates during discharge or charge which can cause overheating. A resulting unsafe operating condition can be detected by temperature sensors or by being detected as an excess internal operating pressure level through pressure sensors, as described in more detail hereinafter. An elevated pressure can be created as the gas inside the cell warms.

The system 10 also includes a containment vessel 106 having an air access or inlet conduit 114 and an air egress or outlet conduit 112 in fluid communication with a chamber 105 defined by vessel 106. An access control valve 101, a one way check valve 102, a H₂O scrubber 103 and a CO₂ scrubber 104 are mounted within conduit 114. A one way check valve 107 and a forced air device 108 (such as an electric fan) are mounted within conduit 112. A charge/discharge controller 109 is coupled to battery terminals 115 and 116 and to forced air device 108. Charge and discharge operation of the battery system is controlled by charge controller 109. The pair of, normally closed, one way, check valves 101 and 107 insure that the inside of the containment vessel 106, and therefore the battery cell 15, is sealed within the chamber 105 and isolated from the external environment during periods when the forced air intake device is not active, i.e., the inlet and outlet are sealable by check valves 101 and 107. Only very limited power output is possible under this condition. Applying a load to the battery cell 15 will deplete the oxygen within containment vessel 106 and cause the battery cell to cease operation.

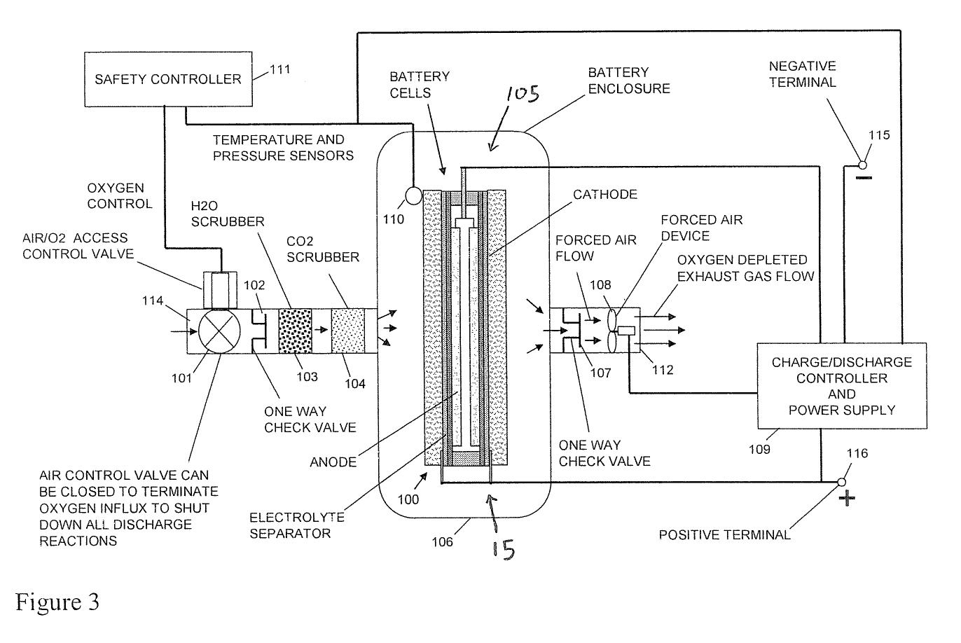

The system 10 further includes a safety controller 111 which is electrically coupled to an environmental sensor 110, such as a sensor or set of sensors capably of sensing the pressure and/or temperature, and to an oxygen flow control valve 101. When an unsafe or undesired temperature or pressure condition is detected by safety controller 111, it closes oxygen valve 101 to shut down operation of the battery and thereby prevent a catastrophic event. The schematic diagram of FIG. 3 depicts an electronic controller; however, a mechanical thermally actuated valve would be a suitable substitute as well.

During operation, when output power is required, controller 109 activates forced air device 108 thereby causing check valves 102 and 107 to open and allow continuous fresh oxygen/air to flow through the battery cell. Scrubbers 103 and 104 extract water and carbon dioxide from air flowing into the battery cell. In order to preclude premature saturation of the scrubbers by the abundant levels of water and carbon dioxide gases in the atmosphere, the forced air intake device is activated only when necessary. As a safety feature, the charge controller terminates air influx to shut down discharge reactions if it detects an unsafe condition such as a temperature or pressure that is beyond a desired set point.

At 50% relative humidity, ambient air typically contains 10 g of water for every 1000 g of air. At this same humidity level, drying agents such as silica gel and calcium oxide have a moisture capacity of approximately 30 wt %. Ambient air normally contains 21% O₂. Therefore, for every 3000 g of air, 100 g of calcium oxide (CaO) is required to produce the dry air equivalent of 628.5 g O₂. This corresponds to a need for a mass of desiccant that is approximately 16 wt % of the required mass of O₂. Ambient air typically also contains 0.038 wt % CO₂, corresponding to 0.38 g CO₂ for every 100 g of air. A CO₂ scrubber such as Ascarite II can absorb 20-30 wt % CO₂, or approximately 25 g CO₂ for 100 g of Ascarite. Therefore, 100 g of Ascarite will scrub an amount of air equivalent to approximately 138 kg O₂. This corresponds to a need for a mass of CO₂ scrubber that is 0.07 wt % of the required mass of O₂.

Thus, the total mass of scrubber required is approximately 16 wt % of the total oxygen mass. This compares closely to the mass required for a pressure vessel, which is approximately 14 wt % of the mass of oxygen contained, independent of the pressure.

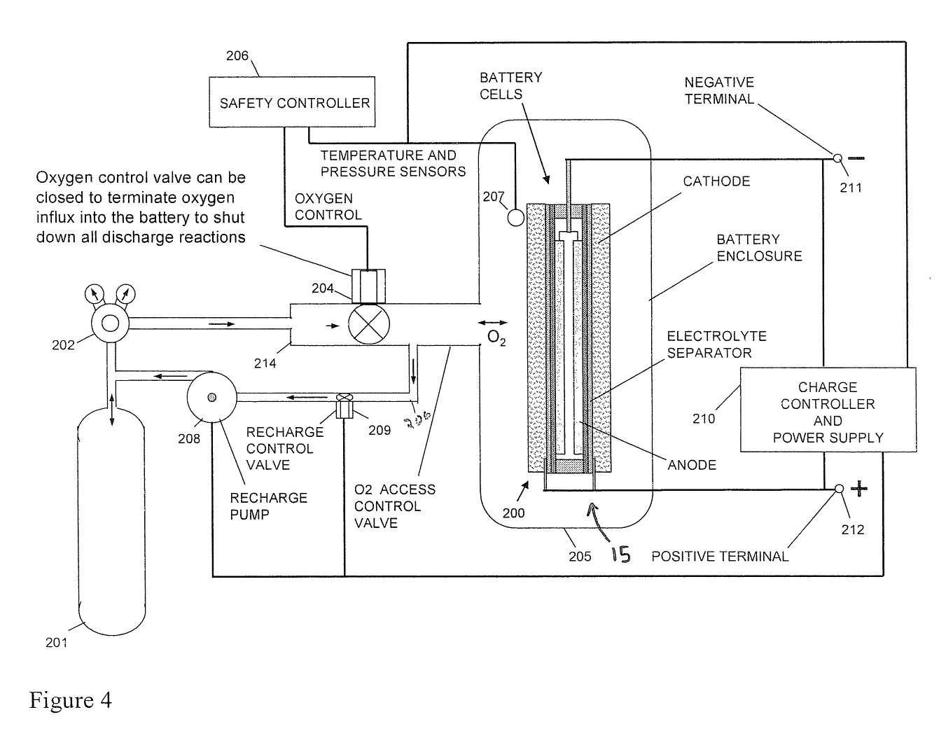

With reference next to FIG. 4, there is shown another preferred form of the invention wherein oxygen is supplied from an oxygen storage tank 201 as opposed to using oxygen from ambient air. Oxygen storage tank 201 is coupled by pressure regulator 202 to oxygen control valve 204. Regulator 202 supplies oxygen to the battery cell at a desired set pressure. During discharge, the pressure regulator 202 maintains a targeted operating pressure in the cell enclosure or containment vessel 205 by regulating the oxygen flow from oxygen storage tank 201. It is understood that the oxygen tank 201 may be at an elevated pressure to reduce the volume that would otherwise be required for oxygen storage.

The charge controller and power supply 210 are coupled to terminals 211 and 212 of the battery cell, to temperature and pressure sensor 207, to recharge pressure pump 208 coupled to an air outlet conduit 206, and to recharge control valve 209. Pump 208 remains off and charge control valve 209 remains closed during battery discharge. However, when the battery is being recharged, charge control valve 209 is switched to an open position and recharge pump 208 is turned on so that oxygen is pumped back to tank 201 as it evolves during the charge process. Charge controller 210 turns on pump 208 and opens valve 209 in response to detecting a pressure level within the containment vessel 205 that is above a desired set point. Charge controller 210 also does not actuate pump 208 if it detects a temperature that is above a desired set point. Oxygen control valve 204 is closed during recharge to avoid the back flow of oxygen via the pressure regulator.

The primary overall cell reaction in a lithium-air cell is:

2Li+O₂→Li₂O₂

This leads to an oxygen supply requirement of 1 mole of O₂ gas for every two moles of lithium metal in the anode. The capacity of lithium metal is 3.86 Ah/g. The reduction of oxygen during cell discharge occurs at the surface of a carbon cathode. Typical specific capacities for carbon range from approximately 3 to 5.6 Ah/g carbon. Thus, the active components in a typical cell will contribute between 0.44 to 0.59 g/Ah to the cell mass. This leads to oxygen requirements of 0.60 g O₂/Ah.

To minimize cell volume, it is desirable to store oxygen in a pressurized container, and to maximize the energy density of the cell, it is desirable for the pressurized container to have minimal mass. For a given mass of oxygen, the required mass for today's state of the art pressure vessel is approximately 14% of the oxygen mass, independent of pressure. State of the art, lightweight, pressure vessels constructed of wound carbon or glass fiber/polymer composite and a lightweight metal shell such as aluminum are commercially available.

It thus is seen that an air battery system is now provided which overcomes problems with those of the prior art. While this invention has been described in detail with particular references to the preferred embodiments thereof, it should be understood that many modifications, additions and deletions, in addition to those expressly recited, may be made thereto without departure from the spirit and scope of the invention as described by the following claims.

1. A lithium oxygen battery system comprising,
a containment vessel defining a chamber therein, said containment vessel having a sealable inlet and a sealable outlet;
at least one lithium oxygen electrochemical cell positioned within said containment vessel chamber;
a charge controller coupled to said electrochemical cell;
a control valve in fluid communication with said containment vessel inlet which controls the flow of fluids into said containment vessel;
an environmental sensor capable of sensing one or more select environmental conditions within said containment vessel chamber, and
a safety controller coupled to said environmental sensor and said control valve, said safety controller controlling said control valve in response to information received from said environmental sensor,
whereby the safety controller may control the control valve to be actuated to a closed position if a undesired environmental condition is sensed by the environmental sensors to prevent additional oxygen from entering the containment vessel and reacting with the electrochemical cell.

2. The lithium oxygen battery system of claim 1 wherein said containment vessel inlet is coupled to a pressurized source of oxygen.

3. The lithium oxygen battery system of claim 1 wherein said containment vessel inlet is in fluid communication with ambient air.

4. The lithium oxygen battery system of claim 1 further comprising a flow inducing device for forcing the flow of fluids through said containment vessel.

5. The lithium oxygen battery system of claim 4 wherein said flow inducing device is coupled to and controlled by either said charge controller or said safety controller.

6. The lithium oxygen battery system of claim 3 further comprising a water scrubber which removes water from the air prior to entering said containment vessel.

7. The lithium oxygen battery system of claim 3 further comprising a carbon dioxide scrubber which removes carbon dioxide from the air prior to entering said containment vessel.

8. The lithium oxygen battery system of claim 6 further comprising a carbon dioxide scrubber which removes carbon dioxide from the air prior to entering said containment vessel.

9. A lithium oxygen battery system comprising, a containment vessel defining a chamber therein, said containment vessel having an inlet and an air outlet;
at least one lithium oxygen electrochemical cell positioned within said containment vessel chamber;
safety sensing and control means for sensing the environmental condition within the containment vessel and controlling the flow of fluids through said containment vessel in response to sensed environmental conditions within said chamber,
whereby the sensing and safety control means restricts the flow of fluids into the containment vessel upon detection of an undesirable environmental condition being sensed to prevent additional oxygen from entering the containment vessel and reacting with the electrochemical cell.

10. The lithium oxygen battery system of claim 1 wherein said sensing and control mean includes a control valve in fluid communication with said containment vessel inlet which controls the flow of fluids into said containment vessel, an environmental sensor capable of sensing one or more select environmental conditions within said containment vessel chamber, and a safety controller coupled to said environmental sensor and said control valve, said safety controller controlling said control valve in response to information received from said environmental sensor.

11. The lithium oxygen battery system of claim 9 wherein said containment vessel inlet is coupled to a pressurized source of oxygen.

12. The lithium oxygen battery system of claim 9 wherein said containment vessel inlet is in fluid communication with ambient air.

13. The lithium oxygen battery system of claim 9 further comprising a flow inducing device for forcing the flow of fluids through said containment vessel.

14. The lithium oxygen battery system of claim 13 wherein said flow inducing device is coupled to and controlled by either said charge controller or said safety controller.

15. The lithium oxygen battery system of claim 11 further comprising a water scrubber which removes water from the air prior to entering said containment vessel.

16. The lithium oxygen battery system of claim 11 further comprising a carbon dioxide scrubber which removes carbon dioxide from the air prior to entering said containment vessel.

17. The lithium oxygen battery system of claim 15 further comprising a carbon dioxide scrubber which removes carbon dioxide from the air prior to entering said containment vessel.

18. A lithium oxygen battery system comprising,
a containment vessel having an inlet;
at least one lithium oxygen electrochemical cell positioned within said containment vessel chamber;
a control valve in fluid communication with said containment vessel inlet, said control valve being movable between an open position allowing fluids to pass into said containment vessel and a closed position preventing fluids from passing into said containment vessel;
an environmental sensor capable of sensing one or more select environmental conditions within said containment vessel chamber, and
a safety controller coupled to said environmental sensor and said control valve, said safety controller controlling the position of said control valve in response to information received from said environmental sensor,
whereby the safety controller may control the control valve to be actuated to a closed position if a undesired environmental condition is sensed by the environmental sensors to prevent additional oxygen from entering the containment vessel and reacting with the electrochemical cell.

19. The lithium oxygen battery system of claim 18 wherein said containment vessel inlet is coupled to a pressurized source of oxygen.

20. The lithium oxygen battery system of claim 18 wherein said containment vessel inlet is in fluid communication with ambient air.

21. The lithium oxygen battery system of claim 18 further comprising a flow inducing device for forcing the flow of fluids into said containment vessel.

22. The lithium oxygen battery system of claim 21 wherein said flow inducing device is coupled to and controlled by either said safety controller.

23. The lithium oxygen battery system of claim 20 further comprising a water scrubber which removes water from the air prior to entering said containment vessel.

24. The lithium oxygen battery system of claim 20 further comprising a carbon dioxide scrubber which removes carbon dioxide from the air prior to entering said containment vessel.

25. The lithium oxygen battery system of claim 23 further comprising a carbon dioxide scrubber which removes carbon dioxide from the air prior to entering said containment vessel.
